(19) United States
(12) Patent Application Publication
(10) Pub. No.: US 2026/0326128 A1
(43) Pub. Date: Oct. 22, 2026

(54) Leak-proof structure for gardening water spray gun

(71) Applicant: SHIN TAI SPURT WATER OF THE GARDEN TOOLS CO., LTD, Lukang Township (TW)

(72) Inventor: Chin-Yuan Chen, Lukang Township (TW)

(21) Appl. No.: 19/284,571

(22) Filed: Jul. 29, 2025

(30) Foreign Application Priority Data
Apr. 18, 2025 (TW) 114203957

(51) Int. Cl. B05B 9/01

(52) U.S. Cl. CPC B05B 9/01

(57) ABSTRACT

A leak-proof structure for a gardening water spray gun has a main body, a guiding member, a sealing washer, and a spraying head. The main body has a flow channel and an opening. A socket extends from the guiding member, and a water guiding seat is formed inside the guiding member on the front side of the socket. A water hole is disposed in front of the water guiding seat, and an annulus ring protrudes from the water hole. The sealing washer is a rubber cap, the cap has an end portion and a lid edge connected to each other, an aperture is penetrated in the center of the end portion, and a first stopping edge and a second stopping edge protrude from the outer surface of the end portion along the lid edge and the aperture, respectively.

### BACKGROUND OF THE INVENTION

### Field of the Invention

The present invention relates to a leak-proof structure for a gardening water spray gun.

### Description of the Related Art

Water spray guns are widely used for gardening spraying or cleaning vehicles and other objects. Common water spray guns today often have a gun body with a rotatable spraying head at the front end. The spraying head has one or more water nozzles. Rotating the spraying head changes the shape of the nozzles to achieve a different spray pattern. Furthermore, a water stop ring is installed between the gun body and the spraying head.

However, the conventional structure described above still has the following problems in practical applications: The water stop ring, simply being mounted on the gun body, which cannot prevent the water stop ring from being displaced by the spraying head as it rotates. Consequently, the water stop ring cannot always maintain its optimal water-stopping position to prevent leaks. Consequently, water leaks may occur while the gun is spraying, making it relatively inconvenient to use and easily wasting precious water resources.

Therefore, it is desirable to provide car spoiler for a leak-proof structure for a gardening water spray gun to mitigate and/or obviate the aforementioned problems.

### SUMMARY OF EMBODIMENTS OF THE INVENTION

An objective of present invention is to provide a leak-proof structure for a gardening water spray gun, which is capable of improving the above-mention problems.

In order to achieve the above-mentioned objective, a leak-proof structure for a gardening water spray gun has: a main body, a guiding member, a sealing washer, and a spraying head. The main body has an internal flow channel and an expanded opening in front of the flow channel. A socket extends from the guiding member, and a water guiding seat is disposed inside the guiding member at one side in front of the socket; a water hole is disposed through a closed surface in front of the water guiding seat, and the water hole has a protruding annular ring extending from the water hole; a shaft is installed at a center of the guiding member, and when the guiding member is assembled in the opening, the socket and the flow channel are connected, so that water can be transferred through the flow channel and the socket and then sent to the water guiding seat. The sealing washer is a cap made of rubber and has an end portion and a lid edge connected to each other; an aperture is disposed at a center of the end portion; a first stopping edge and a second stopping edge respectively protrude on an outer surface of the end portion along the lid edge and the aperture; the end portion and the lid edge are configured for covering the water guiding seat and the aperture is mounted on an outer side of the annular ring, so that the sealing washer is able to be positioned on the water guiding seat to prevent the sealing washer from being displaced when the spraying head rotates. The spraying head has an output face with an axis hole at a center of the output face, and a plurality of spray holes with different shapes are arranged on an outer side of the axis hole; the spraying head is pivoted on the shaft of the guiding member with the axis hole, so that the spraying head is capable of rotating on the guiding member to change a shape of the water spray by aligning the water holes with different spray holes; when the spraying head covers the guiding member entirely, the sealing washer presses against the output face of the spraying head with the first stopping edge and the second stopping edge at the same time to enhance an anti-leakage ability through an internal and external water sealing effect.

### BRIEF DESCRIPTION OF THE DRAWINGS

FIG. 1 is a three-dimensional assembly drawing according to a preferred embodiment of the present invention.

FIG. 2 is a three-dimensional exploded drawing of a preferred embodiment of the present invention.

FIG. 3 is a three-dimensional enlarged drawing of a sleeve of the preferred embodiment of the present invention.

FIG. 4 is a three-dimensional enlarged drawing of the positioning sleeve of the preferred embodiment of the present invention.

FIG. 5 is a status drawing of a panel being positioned by the positioning sleeve of the preferred embodiment of the present invention.

FIG. 6 is a cross-sectional drawing of the panel after positioning in the preferred embodiment of the present invention.

FIG. 7 is a cross-sectional view of an assembly according to a preferred embodiment of the invention.

FIG. 8 is another cross-sectional view of the assembly of FIG. 7.

FIG. 9 is an enlarged, detailed cross-sectional view of the assembly of FIG. 7.

### Detailed Description of the Preferred Embodiment

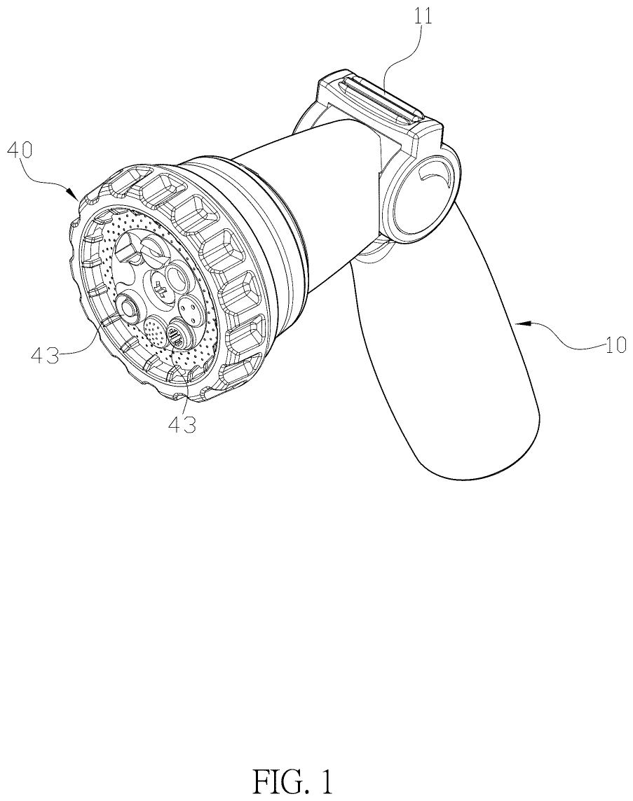

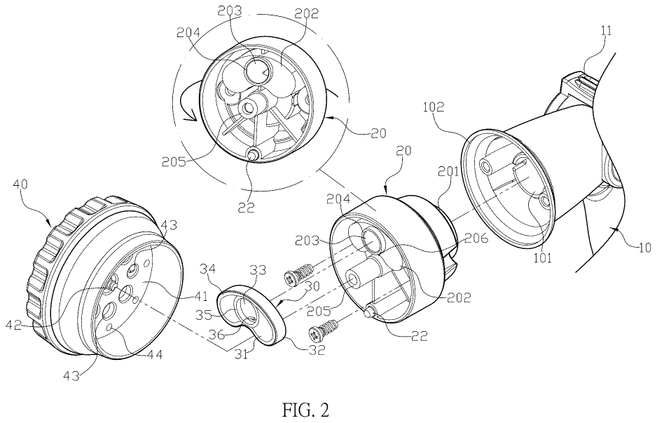

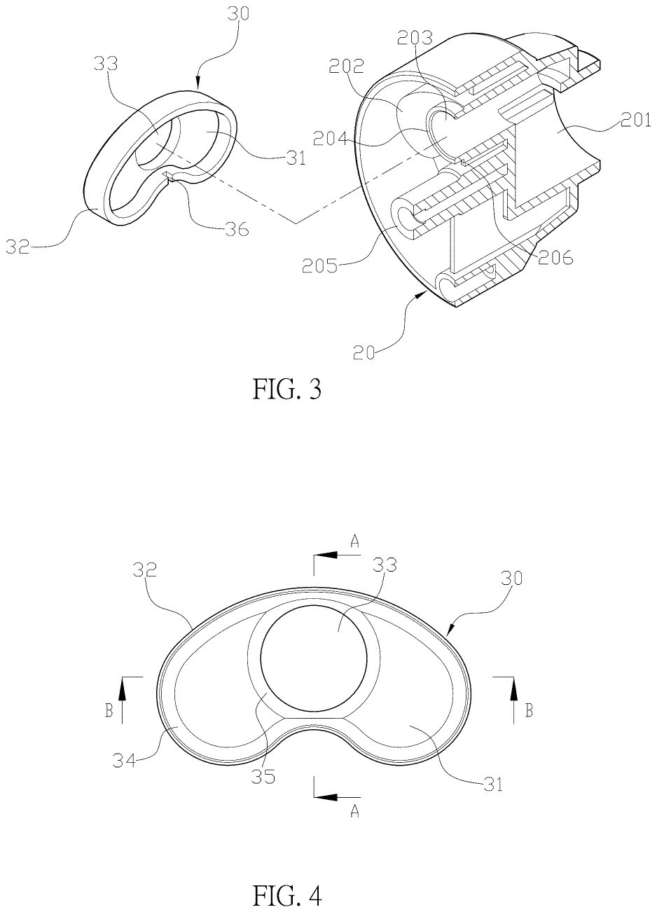

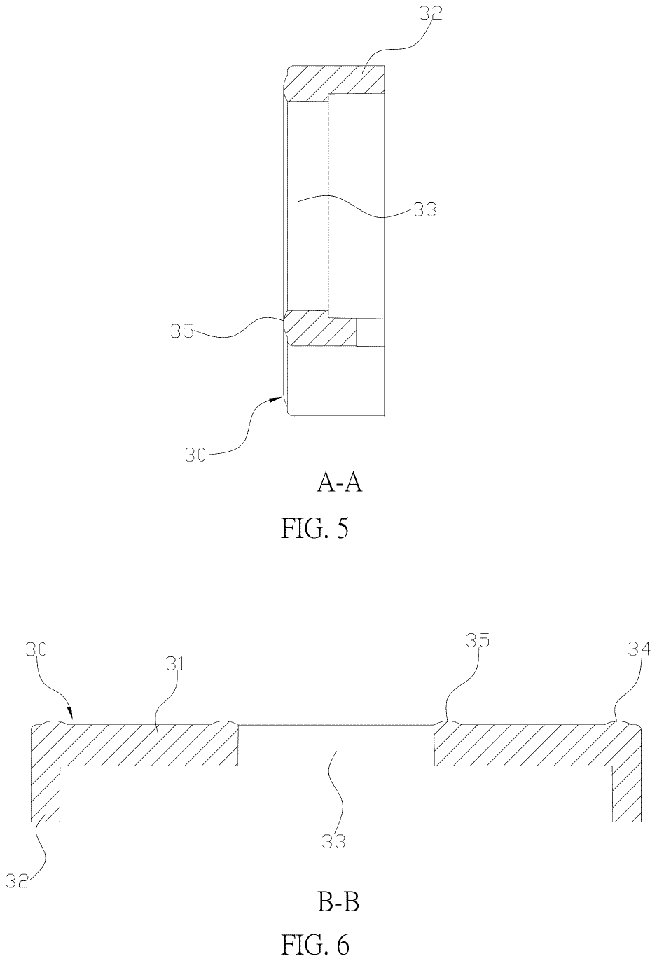

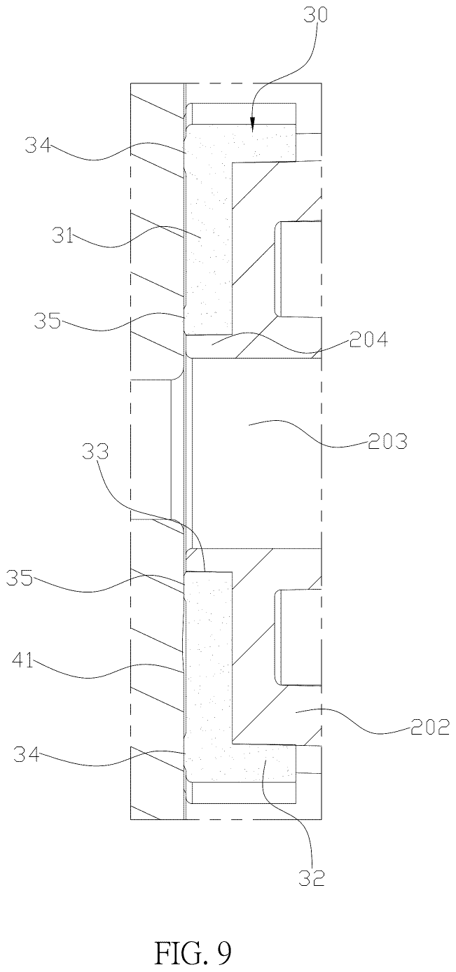

First, please refer to FIGS. 1 to 9. A leak-proof structure for a gardening water spray gun comprises: a main body 10, a guiding member 20, a sealing washer 30 and a spraying head 40. The main body 10 has an internal flow channel 101 and an expanded opening 102 in front of the flow channel main body 10. A socket 201 extends from the guiding member 20, and a water guiding seat 202 is disposed inside the guiding member 20 at one side in front of the socket 201. A water hole 203 is disposed through a closed surface in front of the water guiding seat 202, and the water hole 202 has a protruding annular ring 204 extending from the water hole 202. A shaft 205 is installed at a center of the guiding member 20, and when the guiding member 20 is assembled in the opening 102, the socket 201 and the flow channel 101 are connected, so that water can be transferred through the flow channel 101 and the socket 201 and then sent to the water guiding seat 202. The sealing washer 30 is a cap made of rubber, and the cap and has an end portion 31 and a lid edge 32 connected to each other. An aperture 33 is disposed at a center of the end portion 31. A first stopping edge 34 and a second stopping edge 35 respectively protrude on an outer surface of the end portion 31 along the lid edge 32 and the aperture 33. The end portion 31 and the lid edge 32 are configured for covering the water guiding seat 202 and the aperture 33 is mounted on an outer side of the annular ring 204, so that the sealing washer 30 is able to be positioned on the water guiding seat 202 to prevent the sealing washer 30 from being displaced when the spraying head 40 rotates. The spraying head 40 has an output face 41 with an axis hole 42 at a center of the output face, and a plurality of spray holes 43 with different shapes are arranged on an outer side of the axis hole 42. The spraying head 40 is pivoted on the shaft 205 of the guiding member 20 with the axis hole 42, so that the spraying head 40 is capable of rotating on the guiding member 20 to change a shape of the water spray by aligning the water holes 203 with different spray holes 43. When the spraying head 40 covers the guiding member 20 entirely, the sealing washer 30 presses against the output face 41 of the spraying head 40 with the first stopping edge 34 and the second stopping edge 35 at the same time to enhance an anti-leakage ability through an internal and external water sealing effect.

In addition, the main body 10 has a water valve trigger 11, so that the finger-type water valve 11 can be used to control the opening and closing of water or change the water flow rate.

Moreover, the guiding member 20 is screwed to the main body 10, and the guiding member 20 and the main body 10 are further bonded together by high frequency welding.

Also, the water guiding seat 202 and the sealing washer 30 are arranged in a matching heart shape.

Additionally, the water guiding seat 202 and the lid edge 32 of the sealing washer 30 respectively have at least one limiting rib 206 and at least one limiting notch 36 which can be mutually locked and positioned.

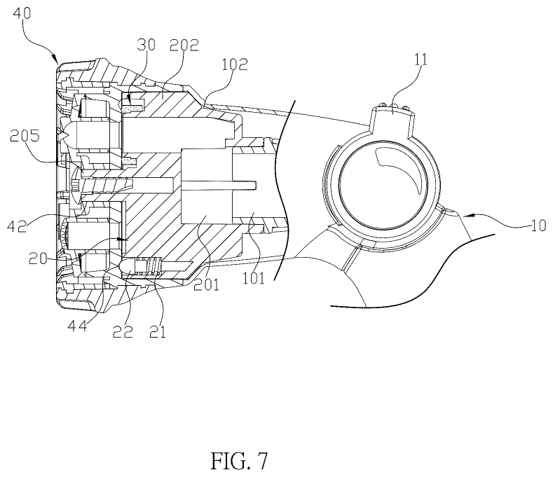

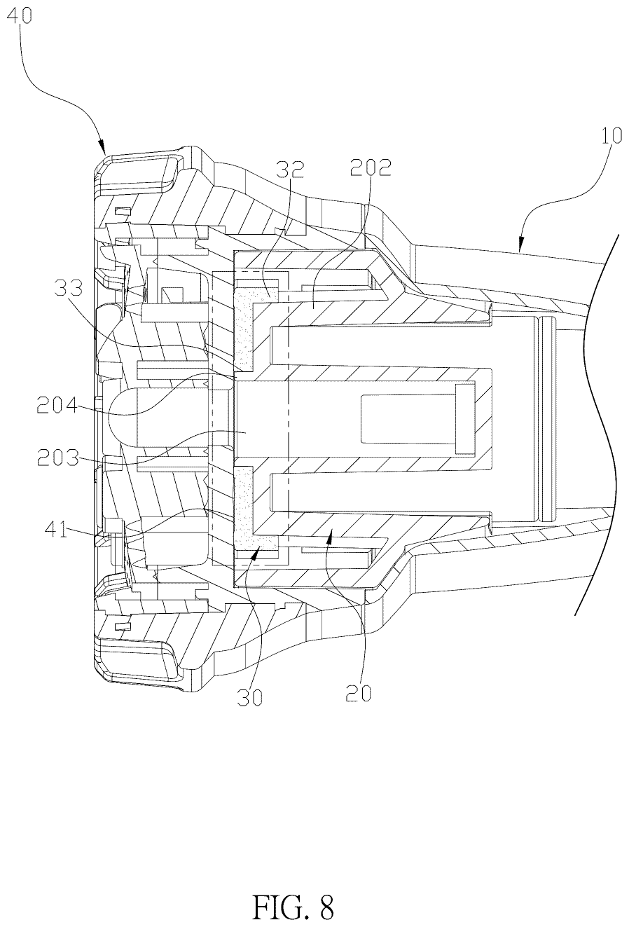

Furthermore, a positioning pin 22 pushed outward by a spring 21 is installed on the guiding member 20, as shown in FIG. 7, and a plurality of positioning holes 44 are recessed on the output face 41 of the spraying head 40. the guiding member 20. With positioning holes 44 allowing the positioning pins 22 to snap into place one by one when the spraying head 40 rotates, so that a clear sense of stepping can be produced during the rotation process.

With the structure of the above-mentioned specific embodiment, the following benefits can be obtained: the sealing washer 30 is fixedly sleeved on the water guiding seat 202, so that the sealing washer 30 is not capable to move when the spraying head 40 rotates, and the first stopping edge 34 and the second stopping edge 35 provided on the outside of the water hole 203 are both simultaneously pressed against the output face 41, such that the water output between the water hole 203 and the spray hole 43 can obtain the double water-stopping effect inside and outside, so that the sealing washer 30 can be leak-proof to avoid the phenomenon of water leakage while spraying water, and the precious water resources can be prevented from being wasted.

Although the present invention has been explained in relation to its preferred embodiment, it is to be understood that many other possible modifications and variations can be made without departing from the spirit and scope of invention as hereinafter claimed.

What is claimed is:

1. A leak-proof structure for a gardening water spray gun comprising: a main body, a guiding member, a sealing washer, and a spraying head; wherein:
the main body has an internal flow channel and an expanded opening in front of the flow channel;
a socket extends from the guiding member, and a water guiding seat is disposed inside the guiding member at one side in front of the socket; a water hole is disposed through a closed surface in front of the water guiding seat, and the water hole has a protruding annular ring extending from the water hole; a shaft is installed at a center of the guiding member, and when the guiding member is assembled in the opening, the socket and the flow channel are connected, so that water can be transferred through the flow channel and the socket and then sent to the water guiding seat;
the sealing washer is a cap made of rubber and has an end portion and a lid edge connected to each other; an aperture is disposed at a center of the end portion; a first stopping edge and a second stopping edge respectively protrude on an outer surface of the end portion along the lid edge and the aperture; the end portion and the lid edge are configured for covering the water guiding seat and the aperture is mounted on an outer side of the annular ring, so that the sealing washer is able to be positioned on the water guiding seat to prevent the sealing washer from being displaced when the spraying head rotates; and
the spraying head has an output face with an axis hole at a center of the output face, and a plurality of spray holes with different shapes are arranged on an outer side of the axis hole; the spraying head is pivoted on the shaft of the guiding member with the axis hole, so that the spraying head is capable of rotating on the guiding member to change a shape of the water spray by aligning the water holes with different spray holes; when the spraying head covers the guiding member entirely, the sealing washer presses against the output face of the spraying head with the first stopping edge and the second stopping edge at the same time to enhance an anti-leakage ability through an internal and external water sealing effect.

2. The leak-proof structure for a gardening water spray gun as claimed in claim 1, wherein the main body has a water valve trigger.

3. The leak-proof structure for a gardening water spray gun as claimed in claim 1, wherein the guiding member is fixed onto the main body with at least one screw.

4. The leak-proof structure for a gardening water spray gun as claimed in claim 1, wherein the guiding member is screwed to the main body, and the guiding member and the main body are further bonded together by high frequency welding.

5. The leak-proof structure for a gardening water spray gun as claimed in claim 1, wherein the water guiding seat and the sealing washer are arranged in a matching heart shape.

6. The leak-proof structure for a gardening water spray gun as claimed in claim 1, wherein the water guiding seat and the lid edge of the sealing washer respectively have at least one limiting rib and at least one limiting notch which can be mutually locked and positioned.

7. The leak-proof structure for a gardening water spray gun as claimed in claim 1, wherein a positioning pin pushed outward by a spring is installed on the guiding member, and a plurality of positioning holes are recessed on the output face of the spraying head.
